(19) United States
(12) Patent Application Publication
(10) Pub. No.: US 2006/0006252 A1
(43) Pub. Date: Jan. 12, 2006

(54) Waterproof labeled cap for end of an irrigation pipe

(76) Inventor: C. Travis Wilson, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/178,089

(22) Filed: Jul. 8, 2005

Related U.S. Application Data
(60) Provisional application No. 60/586,632, filed on Jul. 8, 2004.

(51) Int. Cl. A01G 25/06; E01H 3/04; B05B 15/06

(52) U.S. Cl. 239/200; 239/201; 239/202

(57) ABSTRACT

A top cap assembly for use with tube cap assemblies in sealing access points in irrigation systems. In one implementation, a top cap is coupled to a locator component to remotely locate the tube cap assembly. The locator component includes a metallic portion, an audible response mechanism, or other device that provides indicia usable to locate the tube cap assembly. In another implementation, the top cap includes an advertisement portion configured to removably receive indicia. The advertisement portion includes a grooved insert which receives a business card or advertising label. In another implementation, the top cap and/or base collar include grooves which receive an O-ring, and a portion of the tube cap assembly compresses against the O-ring to create a watertight seal. In still another implementation, a method to identify one or more indicium of a top cap is provided according to the present invention.

### CROSS-REFERENCE TO RELATED APPLICATIONS

This application claims the benefit of priority to U.S. Provisional Patent Application No. 60/586,632, filed Jul. 8, 2004, entitled “WATERPROOF LABELED CAP FOR END OF AN IRRIGATION TUBE” which is incorporated herein by reference, in its entirety.

### BACKGROUND OF THE INVENTION

1. The Field of the Invention

The present invention relates generally to access points to irrigation systems and related apparatus.

2. The Relevant Technology

Sprinkler systems (also sometimes referred to as “irrigation systems”) are increasingly common in both home and agricultural use. Where an owner of a sprinkler system is a homeowner, the increase may be due, in part, to the ease and convenience that these systems provide toward having a healthy lawn or garden. For agricultural owners, irrigation systems are popular because of the ease at which the farmer can monitor and control the distribution of water to the potential crops, thereby allowing maximization of the farmer's yield. Automatic sprinkler systems are particularly useful since they minimize the effort required to keep a lawn or crop in good condition and, in some cases, since they help conserve water by turning on and off only as determined in advance.

Notwithstanding the benefits sprinkler systems provide, sprinkler systems require a certain amount of routine maintenance. For example, sprinkler system components may wear out or be otherwise damaged, thus resulting in necessary repairs to the system. For example, it is not uncommon, in large irrigation systems, to replace one or two sprinkler heads a year. In other cases, it may become apparent that the system is providing inadequate or uneven coverage. In such a case, it may be possible to improve coverage and/or distribution by moving one or more sprinklers to a new location. In other circumstances, pipes may need to be replaced after they freeze and rupture, or other repairs may become necessary. One will appreciate, therefore, that some sprinkler systems will require more maintenance—either in amount or complexity—than other sprinkler systems. With some systems, an owner may be able to perform the sprinkler system maintenance. In other cases, due to the complexity of the needed maintenance or lack of personal know-how, an owner may decide to call a professional service to perform the maintenance.

Frequently, an owner will repeatedly contact the same professional service either because of past satisfaction with the provided service, or due to the professional service's familiarity with the particular system. Some sprinkler systems, however, may go one or more years without needing any repairs or maintenance, and an owner may forget who last performed any work on the system. Alternatively, a new owner may need assistance with a newly acquired sprinkler system and wish to contact someone a who previously serviced (e.g. installed, repaired, maintained, provided parts, etc.) the system. In either case, the owner may have to resort to contacting a professional service provider who either has no familiarity with the system, or who previously performed the services unsatisfactorily.

One common feature of some conventional sprinkler systems is the positioning of one or more access points to the system. Typically, an access point includes one or more valves which allow a user to control water flow throughout all or a part of the sprinkler system. Typically, the access point is embedded within a tube that is at least partially buried in the ground. Often, the tube is covered with a cap that is positioned flush with the ground, such that, to access the one or more valves, the user must first remove at least a portion of the tube cap assembly. When the user (e.g. the home owner or a professional technician) is performing the maintenance on the sprinkler system, the user will typically remove a portion of the tube cap assembly to gain entry to the access point. Where replacement of one or more sprinkler heads or system components becomes necessary, the user may turn off the water flow at the access point, make the necessary repairs or replacements, and turn the water flow back on at the access point to test the system and any new heads.

Despite the ability of tube cap assemblies to preserve access to a sprinkler system, conventional tube cap assemblies may also create a number of problems for the user. For example, components of tube cap assemblies are easy to misplace. Additionally, if the access point is exposed to the elements, the access point is susceptible to rust and corrosion, thus necessitating replacement or repair, and resulting in a greater expense for the owner. Furthermore, because tube cap assemblies are at least partially buried or are flush with the ground, they are often difficult to view, and can sometimes be difficult for a user to find.

Accordingly, an advantage in the art can be realized with sprinkler system tube cap assemblies that can be secured and/or removed and replaced. A further advantage in the art can be realized with a tube cap assembly that can be easily found even though grass or earth has covered the tube cap assembly. A still further advantage in the art can be realized with sprinkler tube cap assemblies that provide a user with immediate indicia of the technician who previously worked on the sprinkler system. Preferably, such indicia would be easy to find and replace as needed.

### BRIEF SUMMARY OF THE INVENTION

The present invention solves one or more problems in the art with systems and apparatus that secure a tube cap assembly to an irrigation pipe or tube, that allow a user to easily locate the tube cap assembly, and that allow a user or owner to readily identify a person or service provider having familiarity with the irrigation system.

For example, one implementation of a top cap used in a tube cap assembly to seal an access point within an irrigation system includes a first surface and an opposing second surface. The top cap can be configured to removably couple to the access point. The top cap can further include a locator component that is operatively coupled to the top cap. The locator component can be used to determine the location of the top cap, even from a remote location.

Another exemplary implementation of a tube cap assembly used in an irrigation system includes opposing top and bottom surfaces. At least one side surface can also be included—either separately from, or integrally with, the top and/or bottom surfaces—and can be used to facilitate securing the tube cap assembly to an access point. Further, an advertisement portion included on the tube cap assembly can be configured to removably receive indicia. The advertisement portion can be located on the top or bottom surface.

In addition, a method in accordance with at least one implementation of the present invention involves positioning a top cap of a tube cap assembly, where the top cap has an advertising portion and is used to seal an access point. In one aspect, the top cap can be removably secured to the access point. The method can further include affixing a name label to the advertising portion of the top cap. As such, a top cap and/or access site can provide a user of the irrigation system with useful information, such as who to contact to obtain parts or service on the system.

Additional features and advantages of exemplary embodiments of the invention will be set forth in the description which follows, and will be, in part, obvious from the description, or may be learned by the practice of such exemplary embodiments. The features and advantages of such implementations may be realized and obtained by means of the instruments and combinations particularly pointed out in the appended claims. These and other features will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view illustrating a tube cap assembly in accordance with the present invention;

FIG. 1B is a plan view illustrating an exemplary embodiment of a top cap for use in a tube cap assembly, according to one embodiment of the present invention;

FIG. 2A is an underside view of an embodiment of a top cap that can be implemented with or without a base collar, and which further includes at least one locator component to assist a user in locating at least a top cap in a tube cap assembly;

FIG. 2B is a cross-sectional view of a tube cap assembly comprising at least a top cap, a base collar, and an O-ring; and

FIG. 3 is an exploded view of a tube cap assembly, also showing a locking mechanism to secure the top cap to the base collar.

### DETAILED DESCRIPTION OF THE PREFERRED EMBODIMENTS

The present invention extends to capping tubular structures used in irrigation systems. In particular, exemplary embodiments of the present invention include waterproof caps having an advertising portion allowing the cap to identify one or more persons or entities that service irrigation systems. Other embodiments of the present invention include locator components to assist a user in finding the location of the tube cap, and may do so with a metal detector or other audio or visual detection/interpretation methods.

As shown and described more fully in the following description and figures, exemplary embodiments of a tube cap can include a top cap configured to releasably couple to a base collar and/or an irrigation tube, and thereby seal an access point in an irrigation system. In some embodiments, the top cap further includes one or more advertising portions configured to allow a user of the irrigation system to, in part, identify a supplier, distributor, installer, repairman, or the like, who has a prior familiarity with the irrigation system or components of the system. One useful aspect of the combination of the tube cap with an advertising member is that the advertising member can include indicia to assist the user of the irrigation system in obtaining parts or services related to that system.

With more particular reference to the top cap portion of the tube cap assembly referred to above, an exemplary implementation of the tube cap assembly includes one or more locator components coupled to the top cap. Generally, the locator components can be selected for compatibility with a particular desired system or device.

More particularly, exemplary locator components irrigation system users in finding a tube cap by emitting an audible sound, or by allowing detection of one or more corresponding magnetic, electrical, or radio detectors/interpreters (e.g., a metal detector for detecting magnetic emissions).

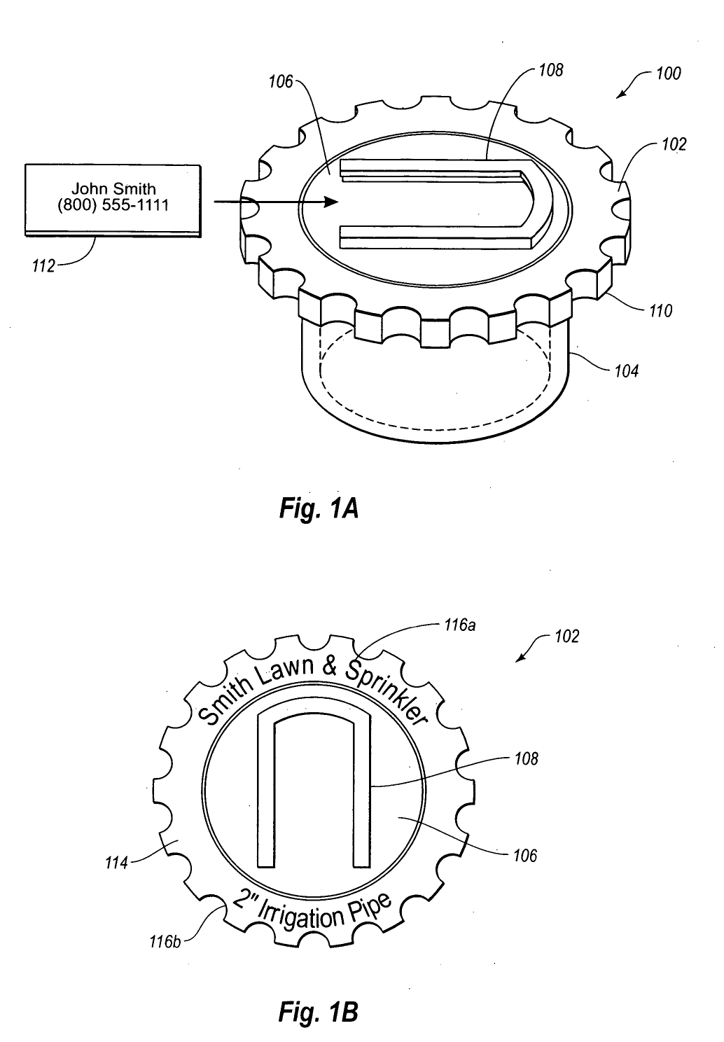

For example, FIG. 1A illustrates a tube cap assembly 100 for use with an irrigation system such as a sprinkler system. In particular, FIG. 1A illustrates that tube cap assembly 100 includes a top cap portion 102 that is coupled to a base collar 104. Base collar 104 is configured to receive an irrigation pipe (not shown) on one end, and to be coupled thereto. An irrigation pipe can be of the type used in any standard irrigation or sprinkler system. The irrigation pipe may also encompass an access point that includes valves, switches, timers, or other components of the irrigation system.

When base collar 104 is coupled to the irrigation pipe, the irrigation pipe remains open on at least one end. Top cap 102 can then be coupled to base collar 104 to thereby form tube cap assembly 100. In connecting top cap 102 to base collar 104, the irrigation tube is sealed off, thereby providing a substantially watertight seal on the irrigation tube and/or access point. In one embodiment, top cap 102 is twisted to be secured to base collar 104, although, as discussed in more detail hereinafter, alternative methods are contemplated in which top cap 102 can be coupled to base collar 104.

In addition, FIG. 1A shows that top cap 102 includes a top surface 106 having an advertising portion 108 coupled thereto. Generally, advertising portion 108 facilitates the provision of useful information to a user or owner of the irrigation system. For example, advertising portion 108 can be configured to provide a user or owner of an irrigation system with information about others with prior familiarity with the irrigation system. Prior familiarity with the system may result, for example, from prior service at the owner's location, from selling parts or components used in the system, or from manufacturing system parts or components.

In this embodiment, advertising portion 108 includes one or more grooved inserts configured to receive a corresponding advertising label 112. A particular feature of a grooved insert in combination with advertising label 112 is the capability of tube cap assembly 100 to provide visible indicia that identify information which can be useful to the user of the irrigation system. For example, advertising label 112 can provide the name, phone number, and/or address or other contact information of an installer, repair service, distributor, or manufacturer. Upon selling a part or providing services related to the irrigation system, a service provider can then insert advertising label 112. This information is useful as it can later assist a user or owner of the system in obtaining service and/or parts, or it can otherwise indicate who may be familiar with the system. In still another alternative, advertising label 112 can serve merely as advertising, and can provide information or advertising unrelated to the sprinkler or irrigation system.

Thus, in one aspect, advertising portion 108 can be configured to removably secure advertising label 112. As a result, advertising label 112 may remain only temporarily within advertising portion 108. For example, as illustrated in FIG. 1A, advertising portion 108 can be open on one end. In this manner, advertising label 112 can be inserted into the grooved insert and can remain in advertising portion 108 until manually removed. Thus, a service provider can remove a pre-existing advertising label and replace it with another to indicate who most recently serviced the system, or to advertise additional services. In other cases, advertising label 112 may be exposed to the elements such that any ink or engraving may wear out. Accordingly, a service provider may periodically monitor advertising label 112. When advertising label 112 wears out, a service provider can remove it and replace it with a newer card or label. In this manner, advertising portion 108 can identify, at different times, multiple entities.

In an alternative implementation, advertising portion 108 can receive multiple advertising labels 112 at one time, such that any number of service providers and/or advertisers can be determined by examining tube cap assembly 100. In still another alternative, advertising portion 108 and/or advertising label 112 can be configured to permanently affix advertising label 112, or otherwise permanently provide indicia of some entity who previously serviced the system, or who has prior familiarity with the irrigation system.

Advertising portion 108 can be configured to receive a variety of sizes and configurations of advertising label 112. In one aspect, advertising portion is sized to receive an appropriately sized personal or business card, or some other type of correspondence card. In still another aspect, advertising portion 108 receives a standard-sized business card. In the illustrated embodiment, advertising portion 108 is substantially U-shaped, as might be used to hold a standard-sized business card. In this manner, the installer, manufacturer, repair service, etc. can use a standard business card with tube cap assembly 100, without the need to customize advertising labels for use with a particular top cap 102.

In alternative embodiments, however, advertising portion 108 can be of other shapes and configurations. For example, advertising portion 108 can be smaller than a business card, and thus configured to accept a smaller advertising label 112. For example, advertising portion 108 could accept a folded business card. Alternatively, advertising portion 108 can be configured to accept other shapes of advertising label 112. For example, advertising portion 108 may be circular so as to receive a chip-shaped advertising label 112.

In some implementations, the outer edge of top cap 102 includes one or more handling grooves 110. Handling grooves 110 can improve a user's ability to manually handle and effectively use top cap 102. For example, irrigation system components, such as top cap 102, can get wet due to residual water. When constructed of materials that become slippery when wet, top cap 102 may be difficult to grip such that a user may have difficulty either removing or installing top cap 102 of tube cap assembly 100. By improving the gribability of top cap 102, installation or removal of top cap 102 is improved by reducing the chance that the user's grip will slip when trying to couple or un-couple top cap 102. The increase in efficiency results in quicker installation or repair of a sprinkler system, and often to a corresponding reduction in labor costs that must be paid by an owner.

With continued reference to FIG. 1A, base collar 104 is coupled to top cap 102. In one embodiment, top cap 102 and base collar 104 are jointly configured to receive each other and to be coupled to the other. It will be appreciated by a person having ordinary skill in the art, however, that this embodiment is not necessarily limiting of the present invention. In some embodiments, only top cap 102 is configured to receive and/or couple to a base collar. For example, top cap 102 may be sized to fit into or onto pre-existing base collars, or directly to an irrigation tube. In this manner, the pre-existing base collar or irrigation tube replaces base collar 104 and acts as a distinct base collar. In exemplary implementations, top cap 102 includes threading or lock fits configured to easily mate with corresponding threads or detents on a pre-existing base collar or irrigation tube.

The shape and size of base collar 104 is configured to couple base collar 104 to an irrigation tube (not shown). In operation, base collar 104 slips over and receives the irrigation tube, and can be secured thereto. Securing base collar 104 to the irrigation tube can be done with any conventional means known in the art. For example, base collar 104 can be secured to the irrigation tube with glue or some other adhesive. Alternatively, base collar 104 and the irrigation pipe can interlock, or clamp together. Alternatively, base collar 104 can be frictionally secured to the irrigation tube, such as with an interference fit.

In the illustrated embodiment, base collar 104 is configured to receive a round irrigation tube (not shown). While irrigation tubes are usually round-also typically resulting in base collar 104 similarly being round-this shape is not necessarily limiting on the present invention. For example, base collar 104 can be configured to receive other, non-conventional irrigation tubes. In another aspect, an inner surface of base collar 104 may be round to receive a conventional irrigation tube, while the outer surface of base collar 104 may have an alternative shape. For example the outer surface could be octagonal, hexagonal, or some other shape which may, for example, assist a user in tightening top cap 102 with a wrench.

It will be appreciated that any number of materials may be used to make base collar 104 and/or top cap 102. Base collar 104 and top cap 102 may be made of the same or different materials. In one aspect, base collar 104 and top cap 102 are made of a plastic material. A number of plastics can be used, although it is preferred that the plastic be non-toxic such that toxins are not transferred when the plastic material is in contact with water. For example, suitable plastics may include acrylonitrile butadiene styrene (ABS) or polyvinyl chloride (PVC), or other durable materials which may be injection molded to form top cap 102 and/or base collar 104.

The embodiment of advertising label 112 illustrated in FIG. 1A is exemplary of the type of label or card that can be used with the present invention. As illustrated, advertising label 112 can include contact information, such as a person or company name and a phone number. It will be appreciated by a person having ordinary skill in the art that advertising label 112 may display informative indicia other than just a name and/or phone number. For example, advertising label 112 can also include other information such as an address, fax number, email address, logo, or other useful information.

In one implementation, advertising label 112 is configured to be removably secured to tube cap assembly 100. For example, advertising label 112 may have an adhesive. In one aspect, the adhesive is secured to the back of advertising label 112 and includes a non-adhesive backing. In such an embodiment, when the backing is removed, advertising label 112 can be used as a sticker on tube cap assembly 100. In this manner, advertising label 112 may be used with or without advertising portion 108.

The sticker would further allow advertising label 112 to be affixed to various other irrigation system components including, for example, a clock, timer, controller, inside a valve box, or on other easily identifiable areas. In an alternative implementation, advertising label 112 includes a magnet. As discussed in more detail hereinafter, top cap 102 can include metallic features. As such, when a magnetic advertising label 112 is placed on top cap 102 that has magnetic metals, advertising label 112 can be removably secured even in the absence of an adhesive, and without a grooved insert on top cap 102.

In still another alternative implementation, advertising label 112 can be sized such that a frictional fit exists between advertising portion 108 and advertising label 112. For example, the thickness of the material used to make advertising label 112 may be about equal to the height of a grooved insert on advertising portion 108. In this manner, advertising label 112 must be forcibly inserted, thereby creating an interference fit, and also resulting in a reduced risk that advertising label 112 will fall out of advertising portion 108, or otherwise be removed prior to manual removal. In one aspect, advertising label 112 is made of plastic or paper, such that it can be produced in large quantities, and at low cost. Alternatively, rubber or thermoplastic materials may be used, and feature an improved resistance to erosion or ink or engraving due to any exposure to the elements. Accordingly, advertising label 112 can be configured for maximum advertising effect over an extended duration.

FIG. 1B illustrates a plan view of top cap 102 for use in tube cap assembly 100, according to an alternative embodiment of the present invention. In this exemplary embodiment, top cap 102 includes both an advertising portion 108 and an informative portion 116a-b. As previously described, advertising portion 108 can be a configured to display visual indicia by receiving an advertising label 112 such as a business card.

In one implementation, informative portion 116a-b provides visible, technical indicia. For example, in the embodiment illustrated in FIG. 1B, informative portion 116a identifies the source of top cap 102. The source of top cap 102 may be indicated with a name, logo, or other information that allows a user of top cap 102 to identify a manufacturer, distributor, retailer, or other supplier. A feature of informative portion 116a is that a user of top cap 102 can readily identify where to obtain replacement parts, or where to obtain additional parts that are already known to work with an irrigation system. Additionally, informative portion 116a can be used to identify to whom a warranty claim can be made if replacement of top cap 102 becomes prematurely necessary.

In one exemplary implementation, 116b provides technical indicia about the size of top cap 102, base collar 104, and/or a corresponding irrigation tube. Informative portion 116b and/or 116a can indicate, for example: the type of valve or access point with which it can be used; a part number of top cap 102 or base collar 104; the size or type of connector used to couple top cap 102 to base collar 104 or to an irrigation pipe; the size of any threads on top cap 102; or the like. In still another implementation, advertising portion 108 is used to provide technical indicia. By including this technical indicia, a professional service provider can readily identify which part(s) or component(s) are necessary and/or used in the irrigation system. The technical indicia also benefits users or owners of irrigation systems. For example, an owner may decide to service the irrigation system without a professional because the technical indicia provides useful information to help ensure that the proper components are purchased and placed in correct operation with each other.

An exemplary informative portion 116a-b, therefore, is located on the top surface 114 of top cap 102. In the illustrated implementation, there is sufficient surface area around the edges of top surface 114, such that top surface 114 can receive informative portion 116a-b. In one aspect, the informative portion can be, in whole or in part, permanently secured to the top cap. For example, where top cap 102 is formed by injection or dip molding, the visual indicia may be included in the mold.

Alternatively, a label or other indicator may be glued or otherwise permanently adhered to top surface of top cap. In still another aspect, informative portion 116a-b may be temporarily affixed to top cap 102. For example, a sticker or temporary adhesive may be placed on top cap 102 to form informative portion 116a-b.

Generally, one will appreciate that informative portion 116a-b may be formed in lieu of, or in the absence of, advertising portion 108. Alternatively, informative portion 116a-b may be positioned under advertising portion 108. Additionally, while advertising portion 108 and informative portion 116a-b are illustrated on top surface 114 of top cap 102, this feature is not necessarily limiting. It is contemplated that in some implementations, either or both advertising portion 108 and informative portion 116a-b can be on the underside or side of top cap 102, or may be included at a suitable location on base collar 104.

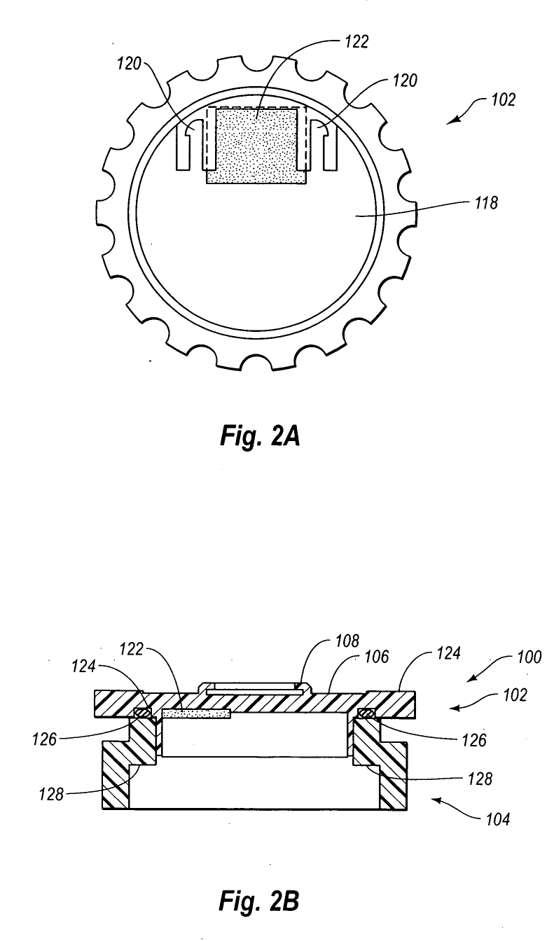

FIG. 2A illustrates an underside view of an exemplary embodiment of a top cap 102 for use according to the present invention. In the illustrated embodiment, top cap 102 includes an underside 118 which further has one or more hooking portions 120 molded into top cap 102. Hooking portions 120 can be configured to couple top cap 102 to: base collar 104; to a valve box; to an irrigation tube; and/or to wires. In one aspect, base collar 104 includes detents which are positioned to correspond with hooking portions 120. In such an implementation, hooking portions 120 can be resilient, such that as the detents are received by hooking portions 120, hooking portions can flex to receive the detents (not shown), and can then snap into place, thereby securing top cap 102 to base collar 104. In an alternative embodiment, wires—such as solenoid wires—are run to one or more valves, and are received by hooking portions 120. In yet another embodiment, hooking portion 120 receives wires from a power source or switch.

An exemplary feature of top cap 102 having hooking portions 120 is the ability to use top cap 102 without base collar 104. For example, hooking portion 120 can be secured to solenoid or other wires, and thereby secure top cap 102 in place inside, or over a valve box or tube. Such an implementation is particularly useful when a watertight seal is not necessary. For example, as will be appreciated by a person having ordinary skill in the art, it may be unnecessary to have a substantially watertight seal on a valve box. Accordingly, top cap 102 can be used to cover a valve box, and can also be coupled to wires within the valve box.

In another implementation, hooking portions can retain visual indicia. For example, advertising label 112 may include a hole or tab that may be inserted into a hooking portion 120. In this manner, when top cap 102 is removed, advertising label 112 can provide a user or owner of the irrigation system with visible indicia about a service provider. Alternatively, advertising label 112 can be secured to the wires received by hooking portion 120.

As illustrated in FIG. 2A, an exemplary embodiment of top cap 102 can further include a locator component 122. Because tube cap assembly 100 may be buried or flush with the ground, it may be covered with earth or grass, or otherwise be difficult to find. In order to find tube cap assembly 100, a user may have to search for tube cap assembly 100 by wandering around an area and/or brushing away dirt or grass.

This could take some time before the user finds an appropriate tube cap assembly 100 that grants access a desired valve box or access point. As such, locator component 122 can be configured to allow a user to identify the location and/or position of tube cap assembly 100 from a remote or local location. Thus, locator component 122 allows a user to quickly and efficiently determine the location of tube cap assembly 100, as well as a corresponding access point.

In an exemplary implementation, locator component 122 is coupled to underside 118 of top cap 102. To facilitate securement of locator component 122 to top cap 102, underside 118 may be hollowed out such that locator component can be removably secured therein. In the embodiment illustrated in FIG. 2A, locator component 122 is positioned substantially within a hollow portion between hooking portions 120. Although underside 118 is hollowed out to correspond with hooking portions 120, it will be appreciated that such a configuration is not necessary. Indeed, other areas of underside 118 may be hollow, or locator component may be secured to top cap 102 without a corresponding hollow portion, and/or to top surface 106 of top cap 102. For example, locator component 122 can be secured to top cap 102 with, a glue or adhesive. Alternatively, screws, rivets, brackets, or other devices may be used to secure locator component 122 to top cap 102. In still another embodiment, locator component 122 may be hung from, or attached to, hooking portion 120.

In one aspect, locator component 122 includes a metallic portion to assist a user in locating tube cap assembly 100. For example, locator component 122 can be a plate made of steel, iron, copper, brass, or other metal. Thus, at least one feature of top cap 102 that includes a metallic plate is that tube cap assembly 100 can be located with a metal detector. Accordingly, even if tube cap assembly 100 is covered with grass or earth, a metal detector can readily identify the location of tube cap assembly 100, and provide that location to a user, thereby decreasing the time and difficulty in accessing an irrigation tube or access point.

A variety of metal detectors are available and can be used to determine the location of top cap 102 and tube cap assembly 100. For example, representative metal detectors suitable to assist in locating tube cap assembly 100 with top cap 102 having a metallic portion include those using magnetic fields and very low frequency (VLF), pulse induction (PI), or beat-frequency oscillation (BFO) technology. When the metal detector, and the associated magnetic field, passes over tube cap assembly 100 and locator component 122, the metal detector can make a user aware that the metal plate is positioned therebelow. A metal detector may use visual indicia (e.g. a display unit) or audio indicia (e.g. a sound that increases in frequency or volume as the metal detector approaches the metal), to identify to the user the location of tube cap assembly 100. In such a manner, even if tube cap assembly 100 is completely buried, a metal detector can readily provide indicia to identify the location of tube cap assembly 100 from a remote location.

In an alternative embodiment, locator component 122 generates audible indicia used to identify the location of tube cap assembly 100. For example, locator component 122 can generate audible response signals with an audio emitter. Locator component 122 can therefore be configured to have the audio emitter send out a permanent or repetitive sound in response to receiving a remote locator signal. Upon emitting an audible sound, a remote user can follow the sound to the location of tube cap assembly 100. In particular, locator component 122 can be set such that the audio emitter is always in an “on” position, and thus always emitting a sound or repeating a sound after pre-determined intervals. In at least one implementation, locator component 122 includes a receiver, such as a receiver component in a transceiver, whereby the locator component 122 can receive a remote locator signal sent from a remote signal generating device held by the user. The receiver is operatively coupled to the emitter such that, upon receiving the remote signal, the receiver switches the emitter to an “on” position, at which time the emitter sends out a sound. Any number of audio emitter/receiver combinations can be used, along these lines. For example, the audible sound may be a beep, chirp, whistle, rattle, horn, tone, a preprogrammed song or voice, or any combination thereof.

Exemplary emitters and/or receiver/emitter (i.e., transceiver) combinations may be powered by a variety of sources. For example, locator component 122 may be powered by DC current, such as from battery or solar power. Alternatively, locator component 122 may be powered by AC current, such as where locator component 122 is hard wired to an AC power source. In addition, various types and configurations of remote signals may be sent to a receiver so as to trigger the emitter. For example, the receiver can be a wireless receiver or directly wired to an electrical switch. In some embodiments of an irrigation system, there are multiple access points and/or multiple tube caps 100. Such a system can be readily configured with a variety of tube caps 100 and locator components 122. Any or all locator components 122 can be configured to receive the same signal to trigger audible indicia of the location of tube cap assembly 100. Alternatively, any or all locator components 122 can be configured to receive different signals such that a specific tube cap assembly 100 is immediately identifiable.

An additional feature of hooking portion 120 is realized when locator component 122 is wired to a power source or switch. In such a case, hooking portion 120 can receive any necessary wires and thereby secure locator component 122. Still further, hooking portion 120 may act as a support for the wires.

Although various exemplary embodiments specifically point out the use of metallic elements and audible indicia to locate tube cap assembly 100, locator component 122 may have other elements to assist in locating tube cap assembly 100. For example, locator component 122 may generate or provide visible response signal indicia. For example, the locator component 122 may cause one or more lights or LEDs to emit light on or above top surface 106 of top cap 102 in response to a remote locator signal in a manner similar to locator component 122 providing audible indicia. Still other implementations contemplate an antennae or flag which may rise from tube cap assembly 100 from a local or remote signal. Still further implementations include the locator component sending inaudible or invisible signals, which are interpreted by a locator device (e.g., having an electrical, magnetic, or radio receiver) held by the user.

FIG. 2B illustrates a cross-sectional view of a watertight tube cap assembly 100 having top cap 102, O-ring 126, and base collar 104. In this embodiment, locator component 122 is secured to underside 118 of top cap 102. In the illustrated embodiment, locator component 122 is at least partially under advertising portion 108. As discussed previously, advertising label 112 can include a magnetic strip; and locator component 122 can include a metallic plate. In such a configuration, the magnetic strip on advertising label 112 can be attracted to the metallic strip on locator component 122. In this manner, locator component 122 is adapted to removably secure advertising label 112 to top cap 102.

In one implementation of top cap 102, groove 124 is formed on underside 118 of top cap 102. Groove 124 can be formed in a variety of methods and can be, for example, molded or milled into top cap 102. In the illustrated embodiment, groove 124 is configured to create a substantially watertight seal between top cap 102 and base collar 104. In one implementation, groove 124 is sized and positioned to receive an O-ring 126. O-ring 126 is configured to substantially seal gaps between top cap 102 and base collar 104, thus providing a substantially watertight seal in tube cap assembly 100. To substantially seal any gaps, O-ring 126 is made of a resilient material. Representative materials suitable for O-ring 126 include, but are not limited to: rubber; silicone; elastomers (e.g. perfluroelastomer); fluorosilicone; urethane; and neoprene. In the illustrated implementation, groove 124 receives O-ring 126 and is positioned such that O-ring 126 is compressed between top cap 102 and base collar 104 as tube cap assembly 100 is formed. In this manner, O-ring 126 seals gaps between underside 118 of top cap 102 and base collar 104.

The location of groove 124 can also allow top cap 102 to couple directly to an irrigation tube and/or other pre-existing base collar. For example, groove 124 can receive O-ring 126, while top cap 102 receives an irrigation tube or pre-existing base collar. Even if top cap 102 does not have a perfect fit with the irrigation tube or pre-existing base collar, an O-ring (e.g. 126) made of resilient material can flex to substantially seal any gaps, thereby creating a watertight seal.

In the illustrated embodiment, groove 124 encircles top cap 102, such that a single groove 124 is formed. It will be appreciated, however, that multiple grooves 124 and/or O-rings 126 may be used. Additionally, groove 124 may be broken up such that (a plurality of grooves 124 are formed, without encircling top cap 102. In alternative implementations it is desirable that groove 124 be formed on base collar 104. For example, top cap 102 can have internal threading, and can receive and fit around at least a portion of base collar 102 that has external threading. As such, top cap 102 can press against O-ring 126, which is positioned in groove 124 on base collar 104, to thereby substantially seal at least a portion of tube cap assembly 100.

In the illustrated embodiment, the bottom of base collar 104 is configured to receive an irrigation tube (not shown), while the top of base collar 104 is configured to receive and/or mate with top cap 102. In one aspect, the internal diameter of at least a portion of base collar 104 can be sized to receive the corresponding irrigation tube. In this manner, base collar 104 receives an irrigation tube and can be secured thereto. Base collar 104 can further have shoulders 128. Shoulders 128 are configured to limit the length of the irrigation tube received by base collar 104. In one implementation, shoulders 128 reduce the internal diameter of base collar 104, and thus stop an appropriately sized irrigation pipe from extending beyond shoulders 128. It is noted that shoulders 128 are optional, and may be absent from base collar 104. For example, top cap 102 can be coupled directly to an irrigation tube, such that the irrigation tube acts as the base collar.

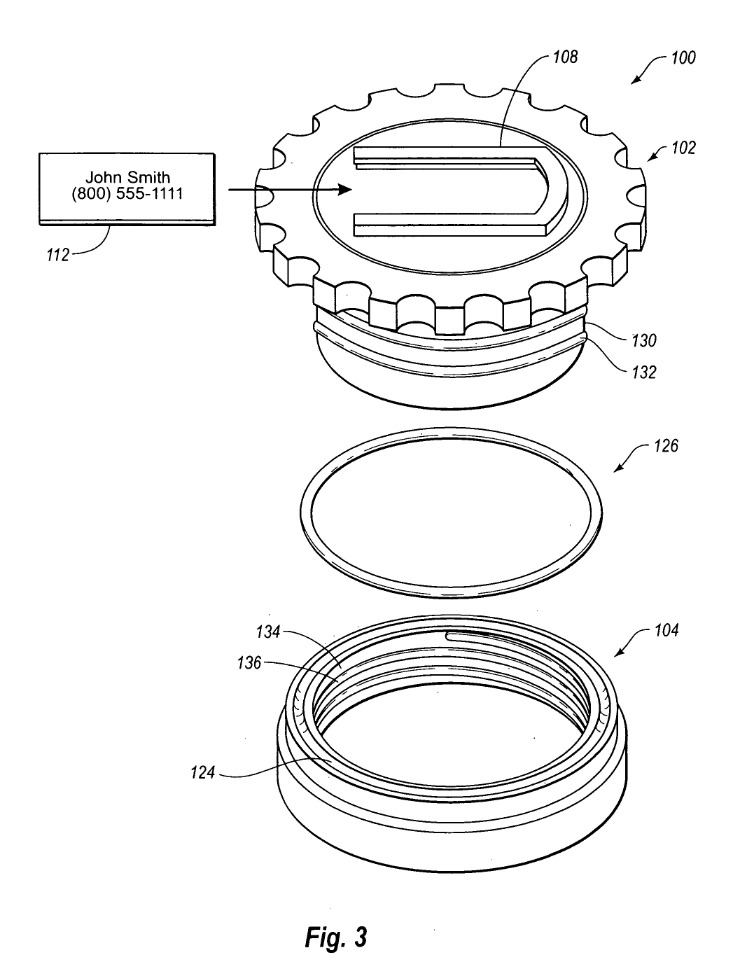

FIG. 3 provides an exploded view of tube cap assembly 100 according to an exemplary embodiment of the present invention. In the illustrated embodiment, tube cap assembly 100 includes top cap 102, base collar 104, and O-ring 126. As previously noted, a particular advantage of utilizing top cap 102 with O-ring 126 and base collar 104 is that tube cap assembly 100 can be configured to provide a substantially watertight seal around an irrigation pipe and/or access point.

In one implementation, top cap 102 includes a side portion 130. Side portion 130 has threading 132 which is configured to act as locking mechanism. In the illustrated embodiment, the locking mechanism facilitates removably coupling top cap 102 to base collar 104, while in other embodiments the locking mechanism facilitates coupling top cap 102 to a pre-existing base collar or directly to an irrigation pipe. In the illustrated implementation, threading 132 is formed on the outside surface of side portion 130. Threading 132 is provided on the outside surface of side portion 130 so as to couple top cap 102 to base collar 104 when top cap 102 is inserted into and received by base collar 104. In alternative embodiments, threading 132 is formed on an internal surface of side portion 130, and side portion 130 may receive and be positioned around base collar 104.

Base collar 104 is configured to couple top cap 102 to an irrigation pipe. As discussed, base collar 104 receives an irrigation tube, and is secured to the tube by glue, adhesive, friction, a clamp, or some other method. Base collar 104 is further configured to receive top cap 102, thereby coupling top cap 102 to the irrigation pipe. For example, in one aspect, base collar 104 is hollow, thus defining an internal surface 134. Threading 136 can be formed on internal surface 134 to correspond to threading 132 on top cap 102. In this manner, top cap threading 132 and base collar threading 136 allow top cap 102 to twist on to base collar 104. This features the advantage of allowing quick and efficient installation of top cap 102, as top cap 102 can be twisted into place and removably secured without the need for messy glues or adhesives.

As will be appreciated by a person having ordinary skill in the art, the present invention is not necessarily limited to threading on top cap 102 and base collar 104, and a variety of other connection methods can be used. For example, it is contemplated that base collar 104 and top cap 102 can be frictionally coupled, secured with a ring clamp, or otherwise interlocked. In still other embodiments, top cap 102 and base collar 104 can be permanently coupled (i.e. secured together such that separation requires at least one of top cap 102 and base collar 104 be broken or otherwise made ineffective for subsequent use). In exemplary embodiments where top cap 102 is permanently coupled to base collar 104, glue or some other adhesive can be used.

Further illustrated in FIG. 3 is O-ring 126, which may be used in conjunction with top cap 102 and base collar 104. As previously detailed, O-ring 126 creates a watertight seal, and can, in some exemplary embodiments, be placed into groove 124 on top cap 102. The use of O-ring 126 does not always require groove 124 on top cap 102. For example, in the illustrated embodiment, groove 124 is formed on base collar 104 and is configured to receive O-ring 126. In this embodiment, O-ring 126 can be fitted within groove 124 and underside 118 of top cap 102 can press against O-ring 126 to create a watertight seal. In other embodiments, O-ring 126 is simply compressed between base collar 104 and underside 118 of top cap 102 without groove 124. In some embodiments, as O-ring 126 is compressed by top cap 102 and base collar 104, it is frictionally secured in place, and compressibly coupled to both top cap 102 and base collar 104.

In still other embodiments, top cap 102 can be configured to fit around a portion of base collar 104. For example, threading 132 can be formed on the inside of side portion 130, and threading 136 can be formed on an outside surface of base collar 104. As such, top cap 102 could fit around and receive base collar 104. In such an implementation, O-ring 126 could be positioned and compressed between base collar 104 and side portion 130 of top cap 102. Additionally, in such an implementation, groove 124 could be formed on base collar 104 and/or on top cap 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. In a tube cap assembly that seals an access point of an irrigation system, a top cap comprising:
opposing first and second surfaces;
a locator component positioned on any of the first or second surfaces, the locator component configured to allow the top cap to be identified from a remote location; and
one or more side surfaces perpendicular to the opposing first and second surfaces, the one or more side surfaces configured to releasably secure the top cap to an irrigation system access point.

2. The top cap as recited in claim 1, further comprising a locking mechanism on any of the first or second surfaces, the locking mechanism being configured to releasably couple to an access point.

3. The top cap as recited in claim 2, wherein the locking mechanism comprises one or more hooking portions positioned on the first or second surface on which the locator component is positioned.

4. The top cap as recited in claim 1, wherein the locator component is metallic, such that the locator component can be identified with a metal detector.

5. The top cap as recited in claim 1, wherein the locator component comprises an audible response mechanism, such that the locator component produces an audible sound including any one of a beep, a chirp, a rattle, a whistle, a tone, a horn, or combinations thereof in response to a remote signal.

6. The top cap as recited in claim 1, wherein the locator component comprises a visible response mechanism, such that the locator component produces a light emission in response to a remote signal.

7. The top cap as recited in claim 1, further comprising an advertisement portion positioned on any of the first or second opposing surface, the advertising portion being configured to removably receive any of a business card, company card, or advertising label.

8. In an irrigation system having one or more access points, a tube cap assembly comprising:
a top cap having opposing top and bottom surfaces, and one or more side surfaces for securing the top cap to an access point;
an advertisement portion positioned on any of the top or bottom surfaces, the advertisement portion being configured to removably receive one or more indicia; and
a base collar configured to receive an irrigation pipe on one end, and to receive the top cap on an opposing end.

9. The tube cap assembly as recited in claim 8, wherein the one or more side surfaces one or more threads, such that the top cap is removed from the base collar by twisting.

10. The tube cap assembly as recited in claim 8, wherein at least one of the top cap or base collar comprises one or more grooves configured to receive an O-ring, such that the top cap creates a substantially water tight seal with the base collar.

11. The tube cap assembly as recited in claim 8, further comprising an informative portion on any of the top or bottom surfaces that identifies one or more of a manufacturer, distributor, retailer, pipe size, or irrigation valve.

12. The tube cap assembly as recited in claim 8, further comprising one or more locator components coupled to any of the top or bottom surfaces of the top cap, the one or more locator components being configured to facilitate one or more responses to a remote signal.

13. The tube cap assembly as recited in claim 8, wherein at least one of the one or more the indicia identifies one or more persons who previously serviced the irrigation system.

14. The tube cap assembly as recited in claim 13, wherein the advertisement portion is configured to receive one or more business cards containing the one or more indicia.

15. In an irrigation system, a method of configuring one or more top caps, such that the one or more top caps readily provide information pertinent to the irrigation system, comprising:
affixing one or more removable indicia to an advertising portion of any of a first or second surface of a top cap; and
releasably positioning the top cap about an access point, such that, upon release, the affixed one or more removable indicia are found.

16. The method as recited in claim 15, further comprising:
removing the top cap; and
replacing the one or more removable indicia with one or more different removable indicia;
wherein the one or more removable indicia and one or more different removable indicia identify a name of one at least partially familiar with one or more aspects of the irrigation system.

17. The method as recited in claim 15, further comprising affixing a power source to a locator component positioned on any of the first or second surfaces of the top cap, such that the locator component can use power supplied by the power source to generate one or more response signals upon receiving a remote locator signal.

18. The method as recited in claim 15, the method further comprising coupling an O-ring to the top cap; and
securing the top cap to the access point, such that the top cap, O-ring, and access point create a substantially watertight seal that includes the one or more removable indicia.

19. The method as recited in claim 15, further comprising sending a remote signal to identify a location of the top cap, wherein the remote signal causes a locator component to generate a response signal.

20. The method as recited in claim 19, further comprising identifying the top cap by interpreting the generated response signal.
